(19) United States
(12) Patent Application Publication
(10) Pub. No.: US 2006/0091064 A1
(43) Pub. Date: May 4, 2006

(54) Filter apparatus with separable seal support frame

(75) Inventors: Gene W. Brown, Franklin, TN (US); Steven J. Merritt, Kearney, NE (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(73) Assignee: Baldwin Filters, Inc., Kearney, NE (US)

(21) Appl. No.: 10/979,867

(22) Filed: Nov. 2, 2004

(51) Int. Cl. B01D 27/00

(52) U.S. Cl. 210/450

(57) ABSTRACT

A sealing apparatus, for operatively and separably connecting a filter element to a filter housing in a manner that seals a juncture between the filter housing and the filter element when the filter element is installed in filter housing, includes a seal member attached to a canted annular extension of a seal support frame. Filter elements and apparatuses incorporating such a separable sealing apparatus are also provided.

### FIELD OF THE INVENTION

This invention relates to fluid filters, and more particularly to filters having a housing adapted for receiving a filter element including a seal member for sealing a juncture between the filter housing and the filter element when the filter element is installed in filter housing.

### BACKGROUND OF THE INVENTION

Filters of the type used for filtering particulate matter from fluid sometimes include a filter housing having an inlet for receiving the fluid with entrained particulate matter, and an outlet for delivering the filtered fluid to a device needing fluid that is free of particulate matter. For example, a filter may be provided at the air inlet of an engine or an air compressor to remove dust, water, or other particulate matter that could cause damage to the engine or compressor if it were not removed from the air entering the engine or compressor.

In such filters, the particulate matter is typically removed by a filter element that is installed within the filter housing in such a manner that the fluid must flow through a filter element, including a filter pack of porous filter material, which removes the particulate matter from the fluid. Over time, the filter pack of the filter element becomes plugged or coated with particulate matter, necessitating removal and replacement of the filter element in order for the filter to continue in its function of supplying particulate-free fluid at the outlet of the housing.

In order to facilitate removal and replacement of the filter element, it is known to configure the filter housing to include a generally tubular wall section thereof, and provide a seal member mounted on the filter element that seals the juncture between an inner surface of the tubular wall section and the filter element, when the filter element is inserted into the housing, so that the fluid cannot bypass the filter element while flowing through the housing. Prior approaches to providing such sealing arrangement are disclosed in U.S. Pat. No. 6,190,432, to Gieske, et al., and in U.S. Pat. No. 6,517,598 B2, to Anderson, et al.

It is desirable to provide an improved filter element, and filter apparatus, having a filter element and sealing arrangement that are more robust than the arrangements used in prior filters. It is also desirable to provide such an improved filter element and filter apparatus in a form that can be manufactured in a more straight-forward and lower cost manner than prior filter elements and filter apparatuses. It is further desirable to provide a such an improved filter element and apparatus in a form which is more readily recyclable and conserves natural resources.

### BRIEF SUMMARY OF THE INVENTION

The invention provides an improved filter element and filter apparatus, for operatively connecting a filter element to a filter housing, through use of a sealing apparatus that is separable from the filter element and housing. The separable sealing apparatus includes a seal support frame, a primary seal member for sealing a juncture between the seal support frame and the housing, and a secondary seal member for sealing a juncture between the seal support frame and the filter element when the filter element is installed in the filter housing using the sealing apparatus of the invention.

Having the sealing apparatus be separable from the filter element allows the sealing apparatus to be re-used, thereby reducing operating costs. Having the sealing apparatus be re-usable is also environmentally more desirable, in that the volume of material that must be discarded or recycled, when the element is replaced, is significantly reduced.

The secondary seal may take a variety of forms, such as an O-ring packing. A sealing apparatus, according to the invention, may also include a secondary seal that is configured in such a manner that the sealing apparatus may function as an adaptor, allowing the use of different configurations of filter elements in the same housing. A sealing apparatus according to the invention also allows for the secondary seal to be of a different type of seal than the seal member attached to the canted annular extension, so that a secondary seal that is well suited to sealing the juncture of the filter element and the separable sealing apparatus can be utilized for that purpose, and a seal member that is well suited for sealing the juncture between the sealing apparatus and the filter housing may be used for that purpose.

In one form of the invention, a sealing apparatus, adapted for sealing a juncture between a filter housing and a filter element installed in the housing, but not including either the filter element or the housing, is provided, for use with filter elements including an outer periphery thereof joining first and second oppositely facing flow faces and defining a longitudinal axis passing through the first and second flow faces. The sealing apparatus includes a seal support frame and a seal member attached to the seal support frame. The seal support frame is adapted for separable connection to one of the first and second flow faces of the filter element and defines a centerline of the seal support frame that extends generally coincident with the longitudinal axis of the filter element when the seal support frame is connected to the filter element. The seal support frame includes a first axial end thereof adapted for separable connection to the filter element and a second axial end thereof forming an annular extension of the seal support frame. The seal member is attached to the annular extension of the seal support frame and defines a sealing surface thereof that is adapted for contacting and sealing against the filter housing.

The annular extension may be canted at an oblique angle to the centerline of the seal support frame. Having the annular extension canted provides a more robust structure that is inherently more capable of withstanding radial and axial forces on the seal member during installation, removal, and operation of the filter element.

The canted annular extension may be angled inward with respect to the centerline, so that the distal end of the canted annular extension has a smaller periphery than the remainder of the canted annular extension. Having the canted annular extension angled inward facilitates installation of the sealing apparatus into a filter housing by reducing the force necessary to compress the seal member between the housing and the annular extension during initial engagement of the seal member with the housing. The seal member may also include a lead-in chamfer for facilitating insertion of the sealing apparatus into the filter housing.

The sealing apparatus may further include a secondary seal support ring, adapted for attachment to the filter element and having an outer surface thereof defining a portion of outer periphery of the filter element, with the secondary seal member being adapted for placement between the seal support frame and the outer surface of the secondary seal support ring. The outer surface of the secondary seal support ring may include a groove for retaining the secondary seal within the groove during insertion of the filter element into the seal support frame.

The filter element may include a filter pack of fluted filter media formed from a porous filter material.

The invention may also take the form of a filter element, a filter apparatus, or a method for forming or using a sealing apparatus, a filter element, or a filter apparatus, according to the invention.

Other aspects, objectives and advantages of the invention will be apparent from the following detailed description and the accompanying drawings.

### BRIEF DESCRIPTION OF THE DRAWINGS

FIG. 1 a cross section of a first exemplary embodiment of the invention, in the form of a filter apparatus.

FIG. 2 is an enlarged partial cross section, of the area within the circle of FIG. 1, showing details of a sealing apparatus, according to the invention, of the filter apparatus of FIG. 1.

FIG. 3 is a partial cross sectional view of a portion of a seal support frame and a primary seal member, of the sealing apparatus of FIG. 2, illustrating an inwardly angled canted annular extension, of the seal support frame, supporting a primary seal member.

FIG. 4 is a perspective view of a second exemplary embodiment of the invention, in the form of a sealing apparatus, for operatively and separably connecting a filter element to a filter housing, but not including a filter element or a filter housing.

FIG. 5 is a cross section of a third exemplary embodiment of the invention, in the form of a filter element.

FIG. 6 is a cross section of a fourth exemplary embodiment of the invention, in the form of a filter element, having a secondary seal support ring, according to the invention that also includes an outer annular peripheral sidewall circumscribing a filter pack, and a bolting flange for securing the filter element to a filter housing.

FIG. 7 is a partial cross sectional view of a portion of a seal support frame and a primary seal member, of an alternate embodiment of the invention, illustrating an outwardly angled canted annular extension, of the seal support frame, supporting a primary seal member.

FIG. 8 is a cross section of an exemplary embodiment of the invention, in the form of a sealing apparatus, according to the invention, having a seal support frame and secondary seal support ring that are configured for threaded mechanical connection to one another.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

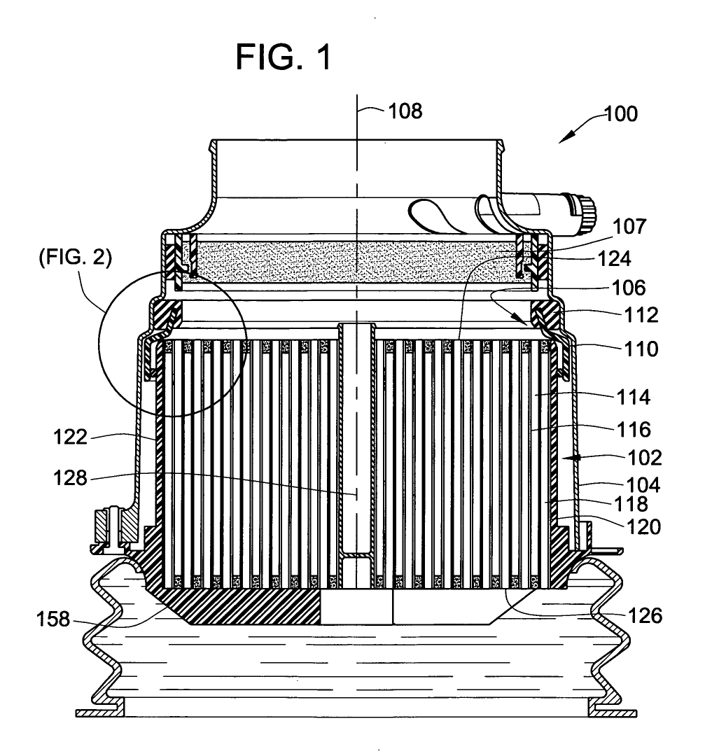

FIG. 1 shows a first exemplary embodiment of the invention in the form of a filter apparatus 100 including a filter element 102, a filter housing 104, and a sealing apparatus 106, for filtering a flow of fluid, entering the bottom and exiting from the top of the filter apparatus 100 (as oriented in FIG. 1). It should be further noted that the filter apparatus 100 of the first exemplary embodiment also includes a safety filter 107, mounted in the filter housing 104 at a point in the fluid flowpath downstream from the filter element 102. Other embodiments of a filter apparatus, according to the invention, may include fewer or more components than the filter assembly 100 of the first exemplary embodiment.

The term fluid as used herein is intended to include fluids in either liquid or gaseous forms. The exemplary embodiments shown herein specifically illustrate an air filter of the type used for filtering intake air for engines and air compressors.

The filter element 102 and the sealing apparatus 106 are adapted for insertion into the filter housing 104, along a longitudinal axis 108 of the filter housing 104, with the sealing apparatus 106 including a seal support frame 10 and a primary seal member 112 for operatively and separably connecting the filter element 102 to the filter housing 104. The filter housing 104, filter element 102, the seal support frame 110 and the primary seal member 112 of the filter apparatus 100 of the first exemplary embodiment all have a generally circular cross sectional shape. In other embodiments of the invention, however, these components may have other cross sectional shapes, such as oval, race-track-like (with straight sides joining rounded ends), rectangular, square or polygonal.

The filter element 102 of the first exemplary embodiment includes a filter pack 114 formed from a coil of fluted filter media 116, as is known in the art, having flutes formed by a convoluted sheet of porous filter material 118, and a face sheet 120, also preferably formed from a porous filter material, attached to one side of the convoluted sheet 118. The filter pack 114 includes an outer periphery 122 thereof joining first and second oppositely facing flow faces 124, 126 and defining a longitudinal axis 128 of the filter pack 114 that extends substantially coincident with the longitudinal axis 108 of the filter housing 104, when the filter element 102 is installed in the filter housing 104, and passes through the first and second flow faces 124, 126 of the filter pack 114. The outer periphery 122, first and second flow faces 124, 126, and the longitudinal axis 128 of the filter pack 114 also define an outer periphery, first and second flow faces, and a longitudinal axis of the filter pack element 102, which will be identified in the figures and the following description by the same reference numerals used to identify the identical features of the filter pack 114.

The ends of adjacent flutes in the filter media 116 are alternately blocked, or left open, at the first and second flow faces 124, 126, so that fluid entering open flutes through the second flow face 126 of the filter element 102 (at the bottom of the filter apparatus 100 as shown in FIG. 1) is forced to flow through the sheet of porous filter material 118, and/or the face sheet 120 into an adjacent flute, in order to exit through the first flow face 126 of the filter element 102. The convoluted sheet 118 may be formed by any appropriate process, such as corrugating or pleating, but is preferably formed by gathering, in the manner described in a U.S. patent application, entitled “Gathered Filter Media and Method of Making Same,” bearing the attorney docket no. 502854, assigned to the Assignee of the present invention, filed concurrently herewith and incorporated herein by reference. The filter media 116 may also include an intermediate seal (not shown), as described in a U.S. patent application, entitled “Fluted Filter Media with Intermediate Flow Restriction and Method of Making Same,” bearing the attorney docket no. 502852, assigned to the Assignee of the present invention, filed concurrently herewith and incorporated herein by reference.

Those having skill in the art will recognize, however, that the invention can also be practiced with efficacy using filter packs having medias and constructions other than the fluted media 116 shown and described herein with respect to the exemplary embodiments. It will also be recognized that, although the first and second flow faces 124, 126 of the filter pack 114 and filter element 102 of the exemplary embodiments shown herein are essentially flat and axially facing, in other embodiments of the invention the first and second flow faces may have other profiles, such as convex or concave, stepped, or conical.

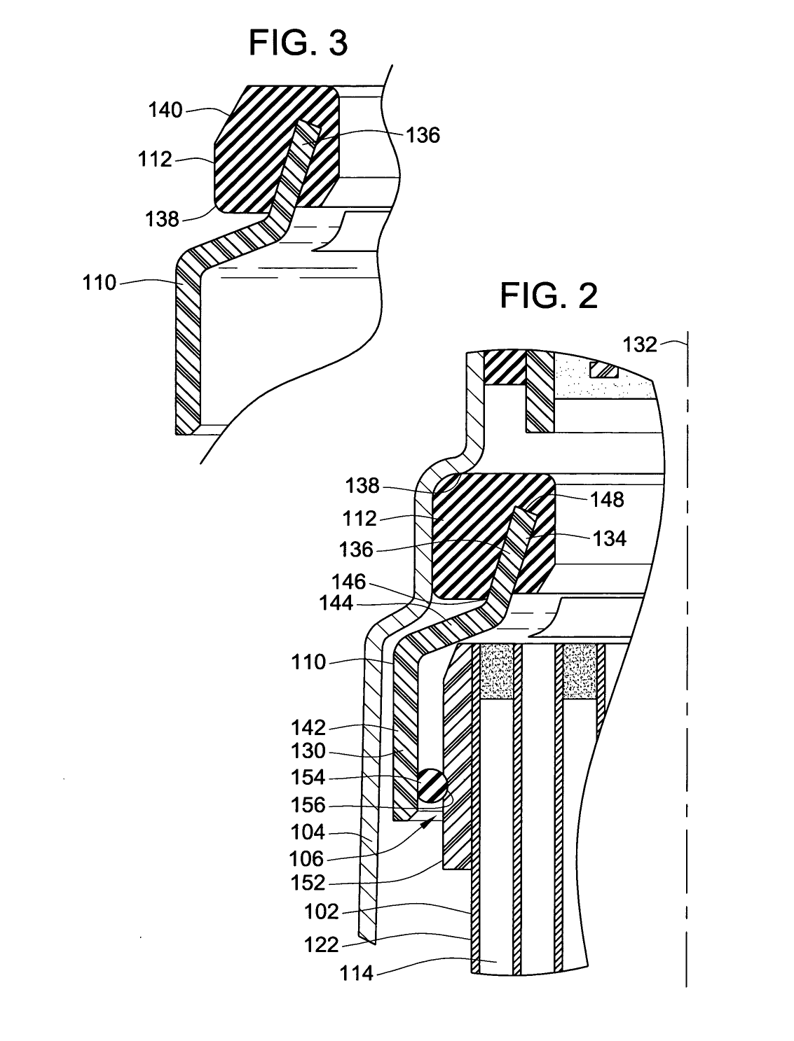

As shown in an enlarged view in FIG. 2, the seal support frame 110 has a first axial end 130 thereof adapted for insertion of the filter element 102 into the seal support frame 110, along a centerline 132 of the seal support frame 110 that extends substantially coincident with the longitudinal axis 108 of the filter housing 104 and the longitudinal axis 128 of the filter element 102 and filter pack 114, when the sealing apparatus 106 is operatively connecting the filter element 102 to the filter housing 104. The seal support frame 106 also has a second end 134 thereof, forming a canted annular extension 136 of the seal support frame 110, which projects at an oblique angle to the centerline 132 of the seal support frame 110.

The term “oblique,” is used herein in accordance with the common dictionary meaning of that word to indicate that the canted annular extension 136 extends at an angle, with respect to the centerline 132 of the seal support frame 110, which is neither parallel nor perpendicular to the centerline 132 of the seal support frame 110. The term “annular,” is also used herein, according to its common dictionary definition, to describe a variety of ring-like shapes disposed about an axis or centerline. Annular shapes, as contemplated by the inventors, may include, but are not limited to, shapes that are round, rectangular, oval, or race-track-like with two generally straight and parallel sides joined by rounded ends.

The primary seal member 112, of the sealing apparatus 106 of the first exemplary embodiment, is attached to the canted annular extension 136 of the seal support frame 110, and defines a sealing surface 138 thereof that is adapted for contacting and sealing against the filter housing 104, when the sealing apparatus 106 is operatively connecting the filter element 102 to the filter housing 104. As shown in FIG. 3, the seal member 112 of the exemplary embodiment includes a lead in chamfer 140 for facilitating insertion of the sealing apparatus 106 into the filter housing 104.

The first axial end 130 of the seal support ring includes a lip 142, which is adapted for circumscribing the outer periphery 122 of the filter pack 114 and filter element 102, and an angled intermediate section 144 extending from the lip 142. The canted annular extension 136 of the first exemplary embodiment extends from a juncture 146, of the canted annular extension 136 with the intermediate section 144 of the first axial end 130 of the seal support frame 110, to a distal end 148 of the canted annular extension 136, and is angled inward, with respect to the centerline 132 of the seal support frame 136, from the juncture 146 to the distal end 148 of the canted annular extension 136, such that the distal end 148 of the canted annular extension 136 has a smaller periphery than the juncture 146.

Having the canted annular extension 136 angled inward provides an advantage during initial insertion of the sealing apparatus 106 into the filter housing 104, by providing additional space between the sealing surface 138 of the primary seal 112 and the distal end 148 of the canted annular extension 136. By virtue of this arrangement, the force required during insertion for compressing the seal member 112 is lowered at the beginning of insertion into the housing 104, and increases progressively as the sealing apparatus 106 is inserted further into the filter housing 104, toward its final installed position as shown in FIGS. 1 and 2. Those having skill in the art will also recognize that having the canted annular extension 136 angled inward, and thus angled in the same direction as the lead in chamfer 140 on the primary seal member 112, results in a greater degree of reduction of initial insertion force that could be achieved through use of either the lead in chamfer 140 or the inward angling of the canted annular extension 136 alone.

As shown in FIG. 2, in the first exemplary embodiment of the invention, the sealing apparatus 106 further includes a secondary seal support ring 150 attached to the outer periphery 122 of the filter pack 114. The seal support ring 150 has an outer surface 152 that forms a portion of outer periphery 122 of the filter element 102. In various embodiments of the invention, the seal support ring 150 may be attached to the outer periphery 122 of the filter pack 114 with an adhesive, or be press fitted onto the filter pack 114.

The sealing apparatus 106 further includes a secondary seal member 154 adapted for placement between the outer surface 152 of the secondary seal support ring 150 and the seal support frame 110 for providing a seal between the seal support frame 110 and the outer periphery 122 of the filter element 102. In the exemplary embodiment of the filter apparatus 100, the secondary seal member 154 is an O-ring packing, and the outer surface 152 of the secondary seal support ring 150 includes a groove 156 for retaining the O-ring within the groove 156 during insertion of the filter element 102 into the seal support frame 110.

In other embodiments of the invention, the secondary seal member 154 may take other shapes or forms, some of which may not require a groove 156 for retaining the secondary seal member in place on the secondary seal ring 150, during insertion of the filter element 102 in to the seal support frame 110. In some embodiments of the invention, where the secondary seal support ring 150 is press fitted onto the filter pack 114, it may be removable and reusable with replacement filter elements 102, in order to reduce both cost of the replacement element 102 and the amount of material that must be discarded or recycled when a filter element 102 is replaced.

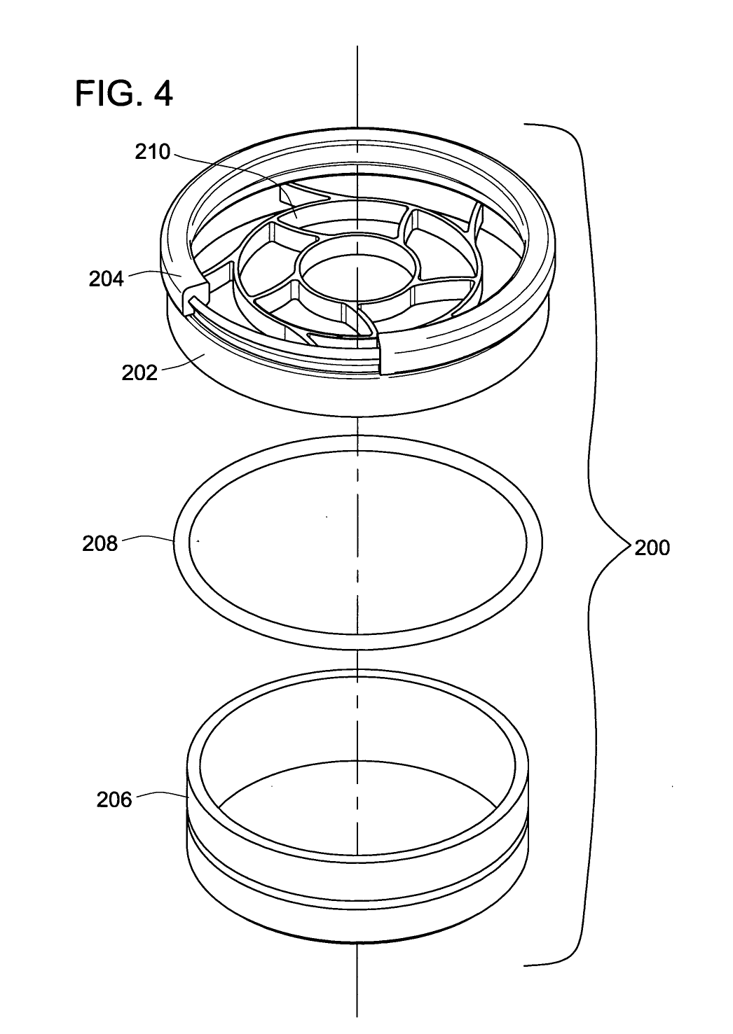

FIG. 4 shows a second exemplary embodiment of the invention, in the form of a sealing apparatus 200, including a seal support frame 202, a primary seal member 204, a secondary seal support ring 206, and a secondary seal member 208, for sealing a juncture between a filter housing and a filter element, but not including either the filter element or the housing. The seal support frame 202, a primary seal member 204, a secondary seal support ring 206, and a secondary seal member 208 of the second exemplary embodiment are identical to the seal support frame 106, primary seal member 112, secondary seal support ring 150, and secondary seal member 154. As shown in FIG. 4, in a sealing apparatus according to the invention, the seal support frame 202 and/or the secondary seal support ring 206 may include a screen 210 or struts extending across the interior to perform functions such as providing resistance to radial stresses, or to provide axial retention of the end of the filter pack.

The second exemplary embodiment of the invention illustrates that a sealing apparatus 200, or parts thereof, according to the invention, may be manufactured or supplied separately from either or both of a filter housing and a filter element. In some forms of the invention, for example, it may be desirable to supply any or all of the components of the seal apparatus 200 (i.e. a seal support frame 202, a primary seal member 204, a secondary seal support ring 206, and/or a secondary seal member 208) as separate parts. In other embodiments, the seal apparatus 200 may include only the seal support frame 202 and the primary seal member 204, with the first end of the seal support frame 202 being adapted for separable insertion of a filter element, not including a secondary seal ring or secondary seal, into the seal support frame 202. Alternatively, a sealing apparatus 200, according to the invention may include only the seal support frame 202, the primary seal member 204, and the secondary seal member 154, with the first end of the seal support frame 202 being adapted for separable insertion of a filter element having its outer periphery sealed to the seal support frame 202 by the secondary seal member 204.

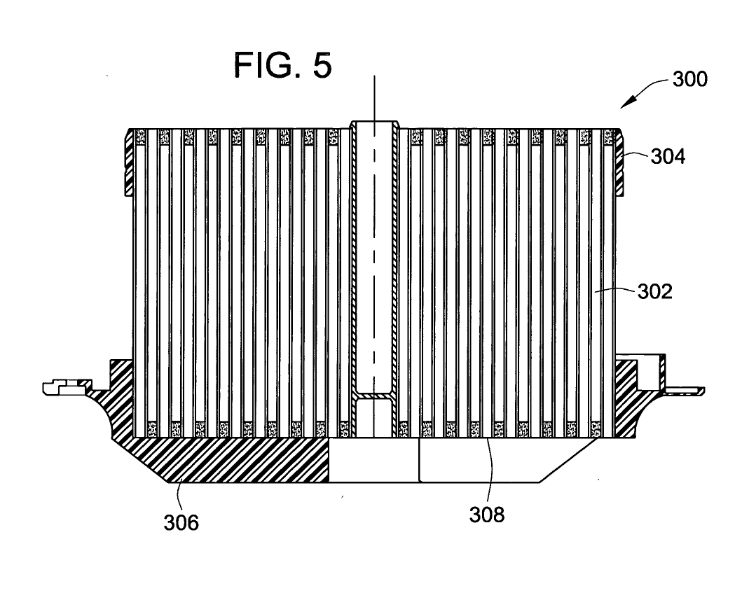

FIG. 5 illustrates a third embodiment of the invention, in the form of a filter element 300 that is adapted for connection to a filter housing through a seal support frame and a primary seal member, according to the invention, but not including the seal support frame, the primary seal member or the housing. The filter element 300, of the third exemplary embodiment, is identical to the filter element 102 of the filter apparatus 100 of the first exemplary embodiment, and includes a filter pack 302, which is identical to the filter pack 114 of the first exemplary embodiment, and a secondary seal support ring 304, which is identical to the secondary seal support ring 150 of the first exemplary embodiment, attached to the outer periphery of the filter pack 302. In various embodiments, the filter element 300 may also include other components of a sealing apparatus, according to the invention, such as a secondary seal member, either affixed to the secondary seal support ring 304 or separable from the secondary seal support ring 304. In some embodiments, a filter element 300, according to the invention, may also include other components similar to those described above in relation to the seal apparatus 200 of the second exemplary embodiment, such as a separable seal support frame having a canted annular extension according to the invention, and a primary seal member which may be affixed to the canted annular seal extension or be separable from the canted seal extension.

It will be further noted that both the filter element 102 of the first exemplary embodiment, and the filter element 300 of the third exemplary embodiment, may include other structures, such as the bolting flange 158, 306, shown in FIGS. 1 and 5, attached to the first flow face 126, 308 of the filter pack 114, 302 for attaching the filter element 102, 300 to a housing.

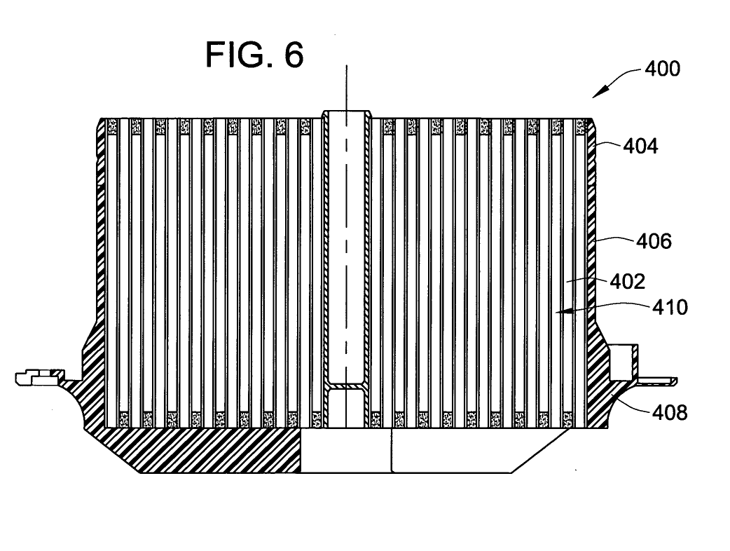

In some embodiments of the invention, a secondary seal support ring, according to the invention, may include additional features and provide additional functionality, as compared to the exemplary embodiments described above. For example, FIG. 6 shows a fourth exemplary embodiment of the invention, in the form of a filter element 400 that is adapted for connection to a filter housing through a seal support frame and a primary seal member, according to the invention, but not including the seal support frame, the primary seal member or the housing. The filter element 400, of the fourth exemplary embodiment, is similar to the filter element 300 of the third exemplary embodiment, except for the configuration of a secondary seal support ring 404, disposed around a filter pack 402. The secondary support ring 404 of the filter element 400 includes an outer peripheral annular sidewall 406 extending from a bolting ring 408, which together form an open ended cavity 410 for receiving the filter pack 402. In some embodiments, a filter element 400, according to the invention, may also include other components similar to those described above in relation to the seal apparatus 200 of the second exemplary embodiment, such as a separable seal support frame having a canted annular extension according to the invention, and a primary seal member which may be affixed to the canted annular seal extension or be separable from the canted seal extension.

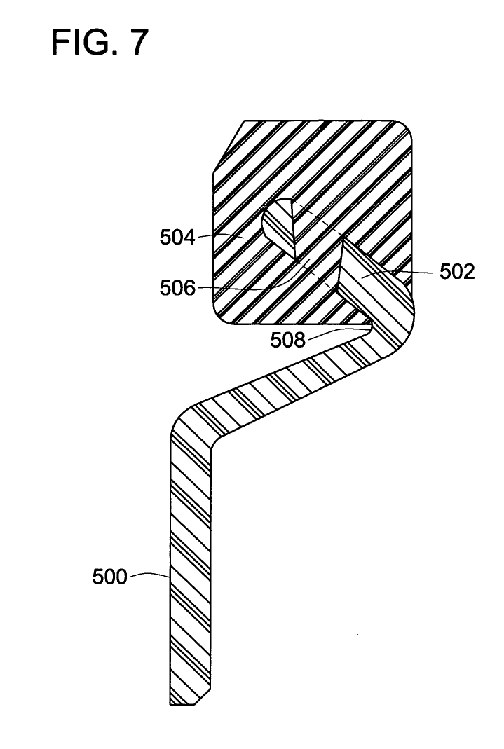

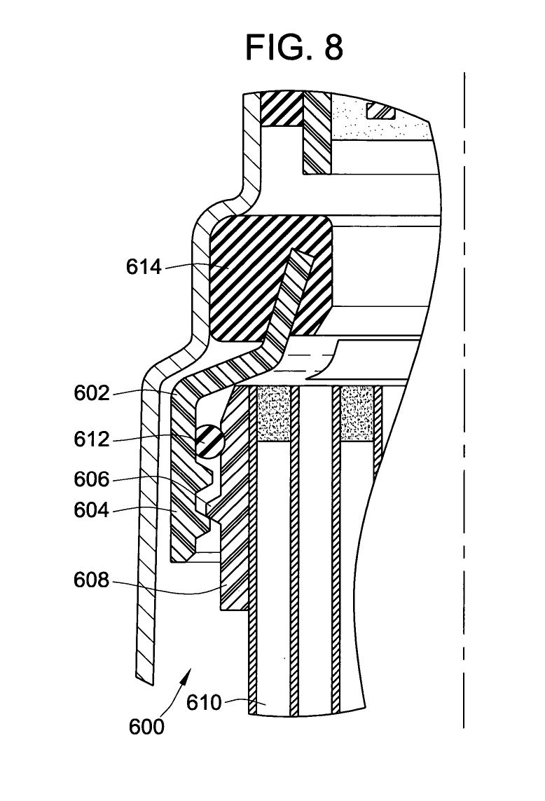

It will also be recognized that, although all of exemplary embodiments of the invention described thus far utilize a canted annular extension that is angled inward, as described above, in other embodiments of the invention it may be desirable to have a canted annular extension 502 of a seal support frame 500 angled outward, as shown in FIG. 7, with a primary seal member 504 being molded onto the canted annular extension 502, and anchored thereupon by portions of the primary seal member 504 that extend through holes 506 in the canted annular extension 502 and into a V-shaped groove 508 of the seal support frame 500.

It will also be recognized that, although all exemplary embodiments of the invention described thus far utilize an operative connection between the filter element and the seal support frame in which an end of the filter element is slidingly inserted into the second end of the seal support frame, in other embodiments, other types of connections may be used. As shown in FIG. 8, for example, a sealing apparatus 600, according to the invention, may include a seal support fame 602 having a female-threaded opening in the second end 604 of thereof for engagement with a male-threaded portion 606 of a secondary seal support ring 608 attached to a filter pack 610. In the embodiment shown in FIG. 8, the sealing apparatus 600 includes a secondary seal member, in the form of an O-ring packing 612, for sealing the juncture between the seal support frame 602 and the secondary seal support ring 608. Those having skill in the art will readily understand that in other embodiments of the invention, other types of mechanical connections, such as bayonet mounts, or snap locks may also be used for connecting the seal support frame to the secondary seal support ring. It will further be understood that, in embodiments of the invention where the mechanical interface is tight enough, between the seal support frame and the secondary seal support ring, a secondary seal may not be necessary.

Those having skill in the art will recognize that a sealing apparatus, according to the invention, provides an advantage in that the primary and secondary seals may have different configurations, and/or be made from different materials, that are specially suited to performing their respective functions. For example, it may be preferable to have the primary seal be formed from a urethane foam to provide a significant degree of compressibility between the housing and the canted annular seal support, to compensate for considerable dimensional differences between housings or elements from different manufacturers, in combination with a secondary seal in the form of an O-ring having relatively small cross section, of a somewhat stiffer material such as flourosilicone or nitrile, so that the outer periphery of the filter pack can be made larger.

The sealing apparatus of the invention makes it possible to use a secondary seal of smaller cross section and stiffer material, because tighter tolerances can be maintained between the outer periphery of the filter pack and the seal support frame, or between the seal support frame and a secondary seal support ring according to the invention. It may also be desirable to use different materials in instances such as the embodiment of FIG. 8, where the seal support frame 602 is connected to the secondary seal support ring 608 by a threaded connection, whereas the primary seal member 614 is configured for a sliding press fit into a housing. In such an embodiment, it may be preferable to utilize a urethane foam material for the primary seal member 614. Such a urethane material might stand up well, however, when subjected to the friction forces generated on the secondary seal member 612, when the seal support frame 602 and secondary seal support ring 608 are threaded together. In such an embodiment, a secondary seal member 614 of a material such as flourosiliclone might be preferable to provide more resistance to damage during threading together the seal support frame 602 and secondary seal support ring 608, while still providing a suitable radial between the seal support frame 602 and secondary seal support ring 608.

The ability to utilize different types or sizes of seals for the primary and secondary seals also provides other advantages, such as adapting a filter pack or element having one type of sealing arrangement for use in a housing designed to receive a filter pack or element having a different type of sealing arrangement. Filter packs of different sizes or outer peripheries can be adapted for use in a common housing, through the use of sealing apparatuses, according to the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A sealing apparatus adapted for sealing a juncture between a filter housing and a filter element installed in the housing, but not including either the filter element or the housing, wherein the filter element includes an outer periphery thereof joining first and second oppositely facing flow faces and defines a longitudinal axis passing through the first and second flow faces, with the sealing apparatus comprising a seal support frame, a primary seal member for sealing a juncture between the filter element and the housing, and a secondary seal member adapted for placement between the seal support frame and the outer periphery of the filter element for providing a seal between the seal support frame and the outer periphery of the filter element, wherein:
the seal support frame is adapted for separable connection to the filter element at one of the first and second flow faces of the filter element and defines a centerline of the seal support frame that extends generally coincident with the longitudinal axis of the filter element when the seal support frame is connected to the filter element;
the seal support frame includes a first axial end thereof adapted for separable connection to the filter element and a second axial end thereof forming an annular extension of the seal support frame; and
the primary seal member is attached to the annular extension of the seal support.

2. The sealing apparatus of claim 1, wherein the filter element includes a filter pack having a fluted filter media formed from a porous filter material.

3. The sealing apparatus of claim 1, wherein the annular extension is canted at an oblique angle to the centerline of the seal support frame.

4. The sealing apparatus of claim 3, wherein the canted annular extension extends from a juncture of the canted annular extension with the first axial end of the seal support frame to a distal end of the canted annular extension and is angled inward, with respect to the centerline of the seal support, from the juncture to the distal end of the canted annular extension, such that the distal end of the canted wall segment has a smaller periphery than the juncture.

5. (canceled)

6. The sealing apparatus of claim 1, wherein the first end of the seal support frame circumscribes the outer periphery of the filter pack.

7. The sealing apparatus of claim 6, wherein the sealing apparatus further comprises:
a secondary seal support ring adapted for attachment to the filter element and having an outer surface thereof defining a portion of outer periphery of the filter element; and
the secondary seal member is adapted for placement between the seal support frame and the outer surface of the secondary seal support ring.

8. The filter apparatus of claim 7, wherein the secondary seal support ring includes a groove, for retaining the secondary seal within the groove during insertion of the filter element into the seal support frame.

9. The sealing apparatus of claim 7, wherein the secondary seal is an O-ring packing, and the outer surface of the secondary seal support ring includes a groove for retaining the O-ring within the groove during insertion of the filter element into the seal support frame.

10. The sealing apparatus of claim 7, wherein the annular extension is canted at an oblique angle to the centerline of the seal support frame and extends from a juncture of the canted annular extension with the first axial end of the seal support frame to a distal end of the canted annular extension and is angled inward, with respect to the centerline of the seal support, from the juncture to the distal end of the canted annular extension, such that the distal end of the canted wall segment has a smaller periphery than the juncture.

11. (canceled)

12. A filter element, adapted for connection to a filter housing through with the sealing apparatus including a seal support frame, and a primary seal member for sealing a juncture between the filter element and the housing, and a secondary seal member adapted for placement between the seal support frame and the filter element for providing a seal between the seal support frame and the filter element, but with the filter element not including the sealing apparatus or the housing, wherein the filter element includes an outer periphery thereof joining first and second oppositely facing flow faces of the filter element and defines a longitudinal axis passing through the first and second flow faces, the seal support frame is adapted for connection to the filter element at one of the first and second flow faces of the filter element and defines a centerline of the seal support frame that extends generally coincident with the longitudinal axis of the filter element when the seal support frame is connected to the filter element, the seal support frame includes a first axial end thereof adapted for separable connection to the filter element and a second axial end thereof forming an annular extension of the seal support frame, and the seal member is attached to the annular extension of the seal support frame, the filter element comprising:
a filter pack including an outer periphery thereof joining first and second oppositely facing flow faces thereof and defining a longitudinal axis passing through the first and second flow faces, with the first and second flow faces of the filter pack and longitudinal axis of the filter pack defining the first and second flow faces and longitudinal axis of the filter element, and the outer periphery of the filter pack partially defining the outer periphery of the filter element; and
a secondary seal support ring attached to the outer periphery of the filter pack and having an outer surface thereof defining a portion of outer periphery of the filter element, with the secondary seal support ring being adapted for operative separable connection to the seal support frame.

13. The filter element of claim 12, wherein the filter pack includes a plurality of flutes of porous filter media.

14. The filter apparatus of claim 12, wherein the secondary seal support ring includes a groove, for retaining the secondary seal within the groove during insertion of the filter element into the seal support frame.

15. The sealing apparatus of claim 14, wherein the secondary seal is an O-ring packing, and the outer surface of the secondary seal support ring includes a groove for retaining the O-ring within the groove during insertion of the filter element into the seal support frame.

16. A filter apparatus comprising:
a filter element adapted for insertion along a longitudinal axis into a filter housing and defining an outer periphery of the filter element; and
a sealing apparatus for operatively and separably connecting the filter element to the filter housing, with the sealing apparatus including a seal support frame, a primary seal member for sealing a juncture between the filter element and the housing, and a secondary seal member adapted for placement between the seal support frame and the outer periphery of the filter element for providing a seal between the seal support frame and the outer periphery of the filter element;
the seal support frame having a first end thereof adapted for insertion of the filter element into the seal support frame along a centerline of the seal support frame that extends substantially coincident with the longitudinal axis when the sealing apparatus is operatively connecting the filter element to the filter housing;
the seal support frame having a second end thereof forming an annular extension of the seal support frame;
the seal member being attached to the annular extension of the seal support frame.

17. The filter apparatus of claim 16, further comprising a filter housing adapted for receiving the filter element and sealing apparatus.

18. The filter apparatus of claim 16, wherein the filter element further comprises a filter pack of fluted porous filter material.

19. The sealing apparatus of claim 16, wherein the annular extension is canted at an oblique angle to the centerline of the seal support frame.

20. The filter apparatus of claim 16, further comprising a secondary seal support ring attached to the outer periphery of the filter element and having an outer surface thereof defining a portion of outer periphery of the filter element.

21. The filter apparatus of claim 20, wherein the secondary seal support ring includes a groove, for retaining the secondary seal within the groove during insertion of the filter element into the seal support frame.

22. The filter apparatus of claim 20, wherein the secondary seal is an O-ring packing, and the outer surface of the secondary seal support ring includes a groove, for retaining the O-ring within the groove during insertion of the filter element into the seal support frame.
